(19) United States
(12) Patent Application Publication
(10) Pub. No.: US 2026/0271841 A1
(43) Pub. Date: Sep. 17, 2026

(54) HYDROGEL SUBSTRATE AS A PLATFORM FOR BIOLOGICAL MATERIAL

(71) Applicant: VERITAS SUBSTRATES, INC., Carlsbad, CA (US)

(72) Inventors: Jenna LUBET, Carlsbad, CA (US); April DAWSON, Carlsbad, CA (US); Julianne TRUONG, Carlsbad, CA (US); Skylar WINDNAGLE, Carlsbad, CA (US); Maria Dolores SAENZ, Carlsbad, CA (US)

(21) Appl. No.: 19/470,672

(22) PCT Filed: Apr. 1, 2024
(86) PCT No.: PCT/US2024/022491

§ 371 Date: Sep. 29, 2025

Related U.S. Application Data
(60) Provisional application No. 63/455,821, filed on Mar. 30, 2023.

(51) Int. Cl. A01G 24/35; A01G 31/00

(52) U.S. Cl. CPC A01G 24/35; A01G 31/00

(57) ABSTRACT

The present application relates to hydrogel substrates for growing biological materials, including but not limited to plants, fungi, and bacteria. In some embodiments, the present application provides a platform for optimizing growth of a biological material using a hydrogel substrate in various forms. In other embodiments, the present application provides methodology and compositions for growing a biological material, such as a plant, in a hydrogel substrate blend comprising hydrogel substrate and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material. In other embodiments, the present application provides methodology and compositions for growing a biological material, such as a plant, in a hydrogel bonded plug, wherein said hydrogel bonded plug does not contain any synthetic adhesive or glue.

### CROSS-REFERENCE TO RELATED APPLICATION

This application claims priority benefit to U.S. Provisional Application No. 63/455,821, filed Mar. 30, 2023, the entire content of which is hereby incorporated in its entirety.

### FIELD

The present application relates to methodology and composition for growing biological material in or on a hydrogel substrate.

### INTRODUCTION

Hydrogels are commonly known water-absorbing polymers comprising about mostly water and a small percentage of organic materials.

Due to their high water content, hydrogels find use in a variety of applications and industries, including food industry, cosmetics, medical devices, agriculture, and other industrial uses.

### SUMMARY

In one aspect, provided a method for growing a plant, comprising
(a) constructing a hydrogel substrate comprising one or more additive ingredients, wherein said hydrogel substrate confers one or more characteristics for supporting plant growth; and
(b) growing a plant in said hydrogel substrate in the absence of soil.

In one embodiment, the one or more additive ingredients is selected from an opacifier additive, a texture additive, a cationic capacity additive, an anti-fouling additive, a humectant additive, and a colorant additive.

In another embodiment, the one or more additive ingredients supports plant growth by conferring one or more characteristics selected from improved nutrient composition, color, light absorption, opacity, elasticity, brittleness, texture heterogeneity, porosity, sterility, antibacterial properties, pH, electrical conductivity (EC), dissolved oxygen, water retention, water capacity, water recirculation, cohesive strength, adhesive strength to non-hydrogel surfaces, freeze-thaw hysteresis, temperature-, light- or pH-based stimuli, gas permeability, shape memory/hysteresis, solvent exchange behavior, thermal conductivity, anti-fouling properties, surface roughness, suspension of solids, compostability, biodegradability, oxidation-reduction potential, cationic exchange capacity, and time dependent release of nutrients.

In another embodiment, the plant is selected from tomato, potato, soybean, maize, turfgrass, rice, oat, wheat, barley, sorghum, orchid, iris, lily, onion, palm, pine, tobacco, Eucalyptus, Populus, Liquidambar, Acacia, teak, mahogany, cotton, tobacco, mustards, orange, apple, pear, cherry, peach, plum, melons, grapes, strawberry, blackberry, raspberry, blueberry, cranberry, loganberry, bananas, citrus, sugar beet, broccoli, cauliflower, celery, lettuce, spinach, eggplant, pumpkin, squash, cassava, sweet potato, pepper, poinsettia, geranium, almond, peanut, pistachio, walnut, bean, alfalfa, carrot, strawberry, lettuce, oak, maple, walnut, rose, mint, squash, daisy, geranium, avocado, artichoke, olives, coconut, jojoba, and cactus.

In another embodiment, the hydrogel substrate comprises a humectant additive, wherein said hydrogel substrate confers increased moisture retention.

In another embodiment, the hydrogel substrate is constructed into a cylindrical hydrogel substrate.

In another embodiment, the hydrogel substrate is constructed into a hydrogel substrate sheet.

In another embodiment, the hydrogel substrate is constructed into irregular porous plug, spheres of uniform or mixed sizes, cubes of uniform or mixed sizes, noodles or fine strings, and irregular polyhedron chunks, and/or mixtures thereof.

In another aspect, provided is a method for growing a plant, comprising
(a) obtaining a hydrogel substrate comprising one or more additive ingredients, wherein said hydrogel substrate confers one or more characteristics for supporting plant growth; and
(b) planting a plant seed or vegetatively propagating a plant, or part thereof, in said hydrogel substrate.

In one embodiment, the hydrogel substrate is constructed into a cylindrical hydrogel substrate.

In another embodiment, the hydrogel substrate is constructed into a hydrogel substrate sheet.

In another embodiment, the hydrogel substrate is constructed into irregular porous plugs; sphere of uniform or mixed sizes, cubes of uniform or mixed sizes, noodles or fine strings, and irregular polyhedron chunks, and/or mixtures thereof.

In another embodiment, the one or more additive ingredients is selected from an opacifier additive, a texture additive, a cationic capacity additive, an anti-fouling additive, a humectant additive, and a colorant additive.

In another aspect, provided is a method for growing a plant, comprising
(a) constructing a hydrogel substrate comprising one or more additive ingredients, wherein said hydrogel substrate confers one or more characteristics for supporting plant growth;
(b) forming said hydrogel substrate into a cylindrical shape to yield a hydrogel substrate cylinder; and
(c) growing a plant in said hydrogel substrate cylinder.

In another aspect, provided is a method for growing a plant, comprising
(a) constructing a hydrogel substrate comprising one or more additive ingredients, wherein said hydrogel substrate confers one or more characteristics for supporting plant growth;
(b) forming said hydrogel substrate into a sheet to yield a hydrogel substrate sheet; and
(c) growing a plant in said hydrogel substrate sheet.

In another aspect, provided is a composition comprising a hydrogel substrate cylinder, wherein the composition does not contain soil.

In one embodiment, the method further comprises a plant.

In another aspect, provided is a composition comprising a hydrogel substrate sheet, wherein the composition does not contain soil.

In one embodiment, the composition further comprises one or more plants.

In another aspect, provided is a method for growing a plant, comprising
(a) obtaining a hydrogel substrate cylinder, wherein said hydrogel substrate cylinder confers one or more characteristics for supporting plant growth; and
(b) growing a plant in said hydrogel substrate sheet in the absence of soil.

In another aspect, provided is a method for growing a plant, comprising
(a) obtaining a hydrogel substrate sheet, wherein said hydrogel substrate sheet confers one or more characteristics for supporting plant growth; and
(b) growing one or more plants in said hydrogel substrate sheet in the absence of soil.

In another aspect, provided is a method for growing a biological material, comprising
(a) obtaining a hydrogel substrate, wherein said hydrogel substrate sheet is shaped, molder, and formed into irregular porous plugs, spheres of uniform or mixed sizes, cubes of uniform or mixed sizes, noodles or fine strings, irregular polyhedron chunks, and/or mixtures thereof; and
(b) growing a biological material on said hydrogel substrate.

In one embodiment, the biological material is a plant, an ornamental flower, fruit, a vegetable, fungus, mushroom, bacterium, or bacterial culture.

In one embodiment, provided is a method of any of the preceding claims, wherein said hydrogel substrate does not comprise methyl cellulose.

In one embodiment, provided is a composition of any of the preceding claims, wherein said hydrogel substrate does not comprise methyl cellulose.

In one aspect, provided is a hydrogel substrate blend, comprising a hydrogel blended with one or more materials suitable for plant growth.

In one embodiment, provided is a raw material is selected from one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

In one embodiment, provided is a hydrogel substrate blend, wherein said blend comprises about 90% coco coir and about 10% hydrogel, based on dry weights.

In one embodiment, a hydrogel substrate blend of any preceding claim, wherein said blend comprises about 90% peat and about 10% hydrogel, based on dry weights.

In another aspect, provided is a hydrogel substrate blend of any of the preceding claims, wherein said blend is an aerosolized product.

In another aspect, provided is a hydrogel substrate blend of any of the preceding claims, wherein said blend is an aerosolized product comprising blended coco coir and wet hydrogel.

In another aspect, provided is a hydrogel substrate blend of any of the preceding claims, wherein said hydrogel substrate does not comprise methyl cellulose.

In another aspect, provided is a method for growing a biological material, comprising
(a) obtaining a hydrogel substrate blend, wherein said hydrogel substrate blend comprises hydrogel and one or more materials suitable for biological growth; and
(b) growing a biological material in said hydrogel substrate blend under conditions suitable for growth of said biological material.

In one embodiment, said one or more materials is selected from soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

In one embodiment, said hydrogel substrate blend comprises hydrogel substrate and coco coir.

In one embodiment, method of any of the preceding claims, wherein said hydrogel substrate blend comprises about 90% coco coir and about 10% hydrogel, based on dry weights.

In one embodiment, said hydrogel substrate blend comprises hydrogel substrate and peat moss.

In another aspect, provided is a hydrogel bonded plug, wherein said plug does not comprise any synthetic glue or adhesive.

In one embodiment, said plug comprises hydrogel substrate and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

In one embodiment, the hydrogel bonded plug of any of the preceding claims, wherein said hydrogel substrate does not comprise methyl cellulose.

In another embodiment, the hydrogel bonded plug of any of the preceding claims, further comprising a biological material.

In another embodiment, the hydrogel bonded plug of any of the preceding claims, further comprising a biological material selected from a plant, an ornamental flower, fruit, a vegetable, fungus, mushroom, bacterium, and bacterial culture.

In another aspect, provided is a compostable hydrogel bonded plug, wherein said hydrogel bonded plug does not comprise any synthetic glue or adhesive.

In another aspect, provided is a method for growing a biological material, comprising
(a) obtaining a hydrogel bonded plug, wherein said hydrogel bonded plug does not comprise any synthetic glue or adhesive; and
(b) growing a biological material in said hydrogel bonded plug under conditions suitable for growth of said biological material.

In one embodiment, said hydrogel bonded plug comprises hydrogel substrate and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material

In one embodiment, wherein said hydrogel bonded plug comprises about 90% coco coir and about 10% hydrogel, based on dry weights.

In one embodiment, in a method of any of the preceding claims, said biological material is selected from a plant, an ornamental flower, fruit, a vegetable, fungus, mushroom, bacterium, and bacterial culture.

In one embodiment, in a method of any of the preceding claims, said biological material is a plant.

In one embodiment, in a method of any of the preceding claims, said plant is selected from lettuce, cilantro, Brassica, herbs, and vegetables.

In one embodiment, in a hydrogel substrate of any of the preceding claims, said hydrogel substrate is dehydrated.

In one embodiment, in a hydrogel substrate blend of any of the preceding claims, said hydrogel substrate blend is dehydrated.

In one embodiment, in a hydrogel bonded plug of any of the preceding claims, said hydrogel bond plug is dehydrated.

In another aspect, provided is a method for growing a biological material, comprising
(a) obtaining a hydrogel substrate, wherein said hydrogel substrate is dehydrated;
(b) rehydrating said hydrogel substrate; and
(c) growing a biological material in or on said hydrogel substrate.

In another aspect, provided is a method for growing a biological material, comprising
(a) obtaining a hydrogel substrate blend, wherein said hydrogel substrate blend is dehydrated;
(b) rehydrating said hydrogel substrate blend; and
(c) growing a biological material in or on said hydrogel substrate blend.

In another aspect, provided is a method for growing a biological material, comprising
(a) obtaining a hydrogel bonded plug, wherein said hydrogel bonded plug is dehydrated;
(b) rehydrating said hydrogel bonded plug; and
(c) growing a biological material in or on said hydrogel bonded plug.

Additional objects and advantages of the embodiments will be set forth in part in the description which follows, and in part will be obvious from the description, or may be learned by practice of the disclosed embodiments. The objects and advantages may be realized and attained by means of the elements and combinations particularly pointed out in the appended claims.

It is understood that both the foregoing general description and the following detailed description are exemplary and explanatory only, and thus not restrictive.

The accompanying drawings, which are incorporated in and constitute a part of this specification, illustrate several embodiments and together with the description, serve to explain the principles of the embodiment.

### BRIEF DESCRIPTION OF THE DRAWINGS

The accompanying drawings, which are incorporated in and constitute a part of this specification, illustrate features made possible by embodiments of the description and together with the description, serve to explain the principles.

FIG. 1: shows an embodiment of making a hydrogel substrate using batch reactor process.

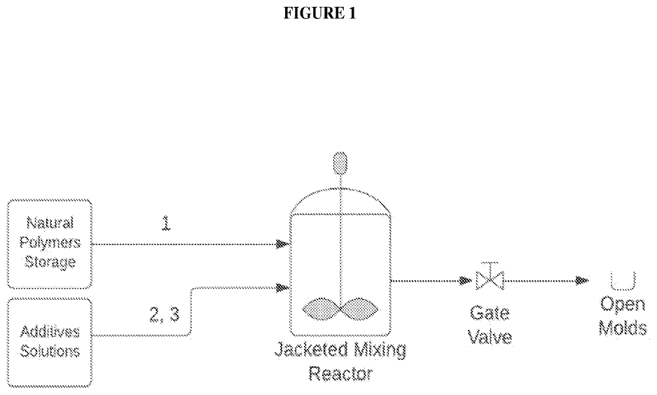

FIG. 2: shows a cylindrical hydrogel substrate for growing a single plant.

FIG. 3: shows a sheet of hydrogel substrate for growing multiple seeds.

FIG. 4: shows an illustrative hydrogel bonded plug comprising hydrogel and coco coir.

FIG. 5: shows an illustrative hydrogel bonded plug comprising hydrogel and coco coir.

### DETAILED DESCRIPTION

The present application provides methodology and compositions relating to hydrogel substrates for agricultural purposes, such as controlled environment agriculture (CEA), hydroponics, aeroponics, aquaculture, green houses, hoop houses, and plant propagation.

As explained below, the present inventors contemplate engineering a hydrogel substrate as a platform for supporting or optimizing growth of a biological material, such as supporting plant growth. In one embodiment, for example, a hydrogel substrate provides a highly customizable platform for providing one or more characteristics for optimizing plant growth. For instance, a hydrogel substrate may comprise one or more components that may optimize plant growth and development, plant nutrition, pathogen resistance, plant flavor and taste, plant stress response, pest resistance, salinity, water uptake and/or availability, cold tolerance, physical strength, plant density, and germination rate and uniformity.

In this regard, a hydrogel substrate can have customizable or engineered features, such as specified pH, electrical conductivity (EC), texture, porosity, dissolved oxygen, sterility, color, light absorption, opacity, elasticity, brittleness, antibacterial properties, water retention, water capacity, cohesive strength, adhesive strength to non-hydrogel surfaces, freeze-thaw hysteresis, temperature-, light- or pH-based stimuli, gas permeability, shape memory/hysteresis, solvent exchange behavior, thermal conductivity, anti-fouling properties, surface roughness, suspension of solids, compostability, ability to pass through filtration systems and permit water recirculation, biodegradability, oxidation-reduction potential, cationic exchange capacity, and time dependent release of nutrients.

In one embodiment, the present inventors determined that the instant hydrogel substrates engineered to specification provide means and composition for supporting biological growth, such as plant growth and development in the presence of soil or in the absence of soil. Depending on the hydrogel substrate composition and depending on the need for growing a particular biological material, a hydrogel substrate may comprise hydrogel without any other growth media, such as soil. However, in other instances, and as explained below, a hydrogel substrate blend may comprise hydrogel and one or more growth materials, including but not limited to coco coir, peat, rock wool, wood, tree fibers, hemp, bamboo, tree barks, wood mulch, sand and grit, perlite, pumice, clay, vermiculite, natural or processed raw materials, and/or synthetic materials.

As detailed more below, an instant hydrogel substrate provides a variety of beneficial attributes for supporting biological growth, such as plant growth, including but not limited to faster and more uniform germination, uniformity in plant plug, shorter growth cycle, improved plant biomass yield, consistent manufacturing output from batch to batch, improved consistency and predictability of performance or outcome from harvest to harvest, improved pest and pathogen resistance, controllable plant nutrient profiles.

For example, water recirculation is an increasing problem in agriculture. That is, when using current and conventional substrates, the substrates release particulate matter into the grow system, which often cannot be filtered and thus reduces the ability for a farm to recirculate water. The present inventors contemplate a hydrogel substrate that can pass through extremely thorough filtration (e.g., 0.3 microns), thus providing the ability for water recirculation. In some embodiments, the filtration is 0.3 microns.

While in no way limiting, and dependent on the needs of the particular biological material, a hydrogel can be engineered to have a specific or customizable pH, customizable electrical conductivity (EC), customizable texture, customizable porosity, customizable dissolved oxygen, sterility, volume and shape of the material, color, light absorption, opacity, elasticity, brittleness, antibacterial, water retention, water capacity, cohesive strength, adhesive strength to non-hydrogel surfaces, freeze-thaw hysteresis, temperature-, light- or pH-based stimuli, gas permeability, shape memory/hysteresis, solvent exchange behavior, thermal conductivity, anti-fouling properties, surface roughness, suspension of solids, compostability, biodegradability, oxidation-reduction potential, cationic exchange capacity, and time dependent release of nutrients.

In some embodiments, an instant hydrogel substrate does not comprise chemically modified polysaccharides, such as chemically modified cellulose. For example, methyl cellulose is a chemically modified cellulose and frequently used as a thickener or emulsifier. In some embodiments, an instant hydrogel substrate does not comprise methyl cellulose. While not bound by any theory, the present inventors believe methylation may increase air porosity in a cellulose-based hydrogel, which may result in a hydrogel having more air pockets or air cavities, and consequently less density.

By creating a novel platform for supporting or optimizing growth of a particular biological material, an instant hydrogel substrate can take any form or shape appropriate for a biological material. For example, and in a non-limiting embodiment, the present inventors contemplate a hydrogel substrate in the form of a cylindrical shape for growing a single plant. Likewise, and in a non-limiting embodiment, a hydrogel substate may take the form of a flat sheet for supporting the growth of many plant seeds or other biological material simultaneously. Additional embodiments may include but not limited to a hydrogel substrate flat sheet for culturing microorganisms and the like. Furthermore, and because a hydrogel is a viscous liquid when manufactured, an instant hydrogel substrate can be shaped, molded, and formed into nearly any necessary shape or format to achieve compatibility with virtually any grow system or format. For example, and in no way limiting, a hydrogel substrate may be shaped, molded, and formed into irregular porous plugs (a sponge-like structure with holes), spheres of uniform or mixed sizes, cubes of uniform or mixed sizes, noodles or fine strings, and irregular polyhedron chunks, and/or mixtures thereof.

Reference will now be made in detail to the present embodiments, examples of which are illustrated in the accompanying drawings. Wherever possible, the same reference numbers will be used throughout the drawings to refer to the same or like parts.

The conjunction “and” or “or” can be used in the list of members, but the “at least one of’ phrase is the controlling language. For example, at least one of A, B, and C is shorthand for A alone, B alone, C alone, A and B, B and C, A and C, or A and B and C.

Technical terminology in this description conforms to common usage in horticulture, biochemistry, agriculture, and the like. This usage and these technical terms are explicated in, for example, Soils and Other Growth Media SBN 333125711 The Macmillan Press.

As used herein, a hydrogel substrate refers to a hydrogel comprising water, gelling agent, cross-linking agent, and may comprise one or more additives that support either a hydrogel itself and/or a biological material growing in, through, and/or on the hydrogel substrate.

As explained below, in some embodiments, a biological material, such as a plant or fungus, can grow in, through, and/or on the hydrogel substrate in the absence of any other growth medium, such as but not limited to coco coir, peat, rock wool, wood, tree fibers, hemp, bamboo, tree barks, wood mulch, sand and grit, perlite, pumice, clay, vermiculite, natural or processed raw materials, and/or synthetic materials, and the like.

In other embodiments, a biological material, such as a plant or fungus, can grow in, through, and/or on the hydrogel substrate in the presence of other growth medium, such as but not limited to coco coir, peat, rock wool, wood, tree fibers, hemp, bamboo, tree barks, wood mulch, sand and grit, perlite, pumice, clay, vermiculite, natural or processed raw materials, and/or synthetic materials, and the like.

In some embodiments, a hydrogel substrate may be dehydrated or freeze-dried for transportation, longer-term use, and/or storage, and such hydrogel substrate is referred to herein as a “dehydrated hydrogel.” Before use, the dehydrated or freeze-dried is rehydrated with water, and referred to herein as a “rehydrated hydrogel.”

In other embodiments, as explained below, a biological material, such as a plant or fungus, can grow in or on a hydrogel substrate blend, comprising hydrogel blended with one or more substrate materials including but not limited to soil, coco coir, peat, rock wool, wood, tree fibers, hemp, bamboo, tree barks, wood mulch, sand and grit, perlite, pumice, clay, vermiculite, natural or processed raw materials, and/or synthetic materials, thereby yielding a blended hydrogel substrate. The terms “hydrogel substrate blend” and “blended hydrogel substrate” are used interchangeably and refer to a blended product comprising hydrogel and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material in varying percentages, compositions, states of matter (solid, liquid, aerosol, etc.), particle sizes, and the like.

A hydrogel substrate may be formed into any shape or format, including but not limited to a hydrogel substrate cylinder, hydrogel substrate sheet, irregular porous plugs (a sponge like structure); spheres of uniform or mixed sizes, cubes of uniform or mixed sizes, noodles or fine strings, and irregular polyhedron chunks, and/or mixtures thereof.

An additive or additive ingredient refers to a composition that supports either a hydrogel itself and/or a biological material growing in, through, and/or on a hydrogel substrate. For example, and in no way limiting, an additive may provide structural support to a hydrogel substrate in the form of tensile strength, elasticity, and the like. Similarly, an additive could support both a hydrogel itself and a biological material, such as a plant, by increasing water capacity and water retention. Likewise, an additive may increase ability to pass through filtration systems and permit water recirculation. Exemplary additives include but are not limited to:
Opacifier: An opacifier additive is a substance added to the hydrogel to tune or control the opacity of the finished material.
Texture: A texture additive is a substance added to the hydrogel to control physical properties of the finished material such as roughness, brittleness, elasticity, adhesive strength, and cohesive strength.
Cationic Capacity: A cationic capacity additive is a substance added to the hydrogel to control its cationic exchange capacity, or ability to retain cations in the hydrogel material.
Anti-Fouling: An anti-fouling additive is a substance added to the hydrogel to prevent the growth of fouling organisms like algae or bacteria.
Humectants: A humectant additive is a substance added to the hydrogel to reduce the loss of moisture from the finished material.
Colorant: A colorant additive is a substance added to the hydrogel to impart a desired pigment or color of the finished material.

A biological material refers to any material produced or derived from a living organism. For example, and in no way limiting, a biological material could include any material from any of the five major taxonomical kingdoms of Plantae, Fungi, Protista, Archaea or Archaebacteria, and Bacteria or Eubacteria. For instance, and in no way limiting, a biological material could include a plant, an ornamental flower, fruit, a vegetable, fungus, mushroom, bacterium, bacterial culture, and the like.

### A. Hydrogel Substrate Composition

Hydrogel substrate comprise several categories of ingredients, each affecting specific attributes and characteristics of the desired substrate. Primary ingredient(s) is/are gelling agent(s) and cross-linking agent(s).

As known in the art, gelling agents come from various sources, such as plants, animals, bacteria, fungi and other sources, as well as synthetic gelling agents. Gelling agents are polymeric materials comprising sugar molecules, polysaccharides, amino acids, proteins, acrylates, acrylamides, glycols, and/or vinyls. Exemplary gelling agents include but are not limited to cellulose, starch, lignin, pectin, carrageenan, and gum. The gelling agent typically represents about 0.5-2.5% of the solution by weight, but can vary depending on particular needs, with water representing the rest of the base solution.

For example, and in no way limiting, an instant hydrogel may comprise gelling agent in an amount of about 0.5% of the solution by weight, about 0.6% of the solution by weight, about 0.7% of the solution by weight, about 0.8% of the solution by weight, about 0.9% of the solution by weight, about 1.0% of the solution by weight, about 1.1% of the solution by weight, about 1.2% of the solution by weight, about 1.3% of the solution by weight, about 1.4% of the solution by weight, about 1.5% of the solution by weight, about 1.6% of the solution by weight, about 1.7% of the solution by weight, about 1.8% of the solution by weight, about 1.9% of the solution by weight, about 2.0% of the solution by weight, about 2.1% of the solution by weight, about 2.2% of the solution by weight, about 2.3% of the solution by weight, about 2.4% of the solution by weight, and about 2.5% of the solution by weight. In some embodiments, an instant hydrogel may comprise gelling agent in an amount of about 0.5% of the solution by weight, about 0.6% of the solution by weight, about 0.7% of the solution by weight, about 0.8% of the solution by weight, about 0.9% of the solution by weight.

In some embodiments, an instant hydrogel does not comprise chemically modified polysaccharides, such as chemically modified cellulose. For example, methyl cellulose is a chemically modified cellulose and frequently used as a thickener or emulsifier. In some embodiments, a present hydrogel does not comprise methyl cellulose. While not bound by any theory, the present inventors believe methylation may increase air porosity in a cellulose-based hydrogel, which may result in a hydrogel having more air pockets or air cavities, and consequently lower density.

Cross linking agent(s) can be ionic or nonionic, having a minimum of two functional sites to create ionic or covalent chemical bonds between gelling agents. The cross-linking agent(s) typically represents about 0.001-1.0% of the solution by weight, with gelling agent and water representing the rest of the base solution. After a base solution of water, gelling agent(s), and cross-linking agent(s) have been mixed, secondary ingredients, so called Additives, can be added to the solution to develop specific substrate attributes and characteristic for the intended use of the substrate.

Additives typically, but not in all cases, collectively represent about 0.5-2% of the solution by weight. Additives are selected to engineer specific attributes and characteristics into the substrate, based on how it is intended to be used or for which crop(s) it is intended to be optimized for. For example, for certain crops a texture or porosity additive may be included; while for other crops that additive is not beneficial, or even potentially detrimental. Furthermore, different amounts of the same additives may be used selectively for specific crops. For example, some crops prefer a higher pH substrate, resulting in the increase of a pH additive for that crop, while other crops might prefer a lower pH substrate and use less of that same additive. In some instances, additives themselves impart secondary attributes beyond their primary attribute (e.g., for pH control); thus some crops may actually prefer the use of a different pH additive than another crop might.

Additives are used to affect hydrogel characteristics such as nutrients, color, light absorption, opacity, elasticity, brittleness, texture heterogeneity, porosity, sterility, antibacterial pH, electrical conductivity (EC), dissolved oxygen, water retention, water capacity, cohesive strength, adhesive strength to non-hydrogel surfaces, freeze-thaw hysteresis, temperature-, light- or pH-based stimuli, gas permeability, shape memory/hysteresis, solvent exchange behavior, thermal conductivity, anti-fouling properties, surface roughness, suspension of solids, compostability, biodegradability, oxidation-reduction potential, cationic exchange capacity, and time dependent release of nutrients. Many additives are known in the art and include, but are not limited to opacifier additives, texture additives, cationic capacity additives, anti-fouling additives, humectant additives, and colorant additives.

The ability to selectively assemble specific ingredients to achieve a specific type of substrate is not generally possible using traditional substrates alone, such as peat moss, coconut coir, perlite or other similar “traditional” substrates in the agriculture market. The ability for a hydrogel to be engineered from the beginning to give, for example, a plant specifically the substrate it prefers is unique in the market and is why such embodiment is novel.

In one embodiment, and unlike conventional uses of hydrogel substates for agricultural purposes, an instant hydrogel substrate is a “substrate medium” and may be a “soilless medium,” since the instant hydrogel is suitable for growing, for example, a plant in a medium that does not contain natural earth soil, in whole or primarily. Similarly, in one embodiment, the instant hydrogel substrate finds use by itself for cultivating mushrooms or other fungi, as well as use in sterile culture. Because the instant hydrogel substrate is the substrate itself for growing or cultivating biological material, the hydrogel substrate can be shaped, molded, and formed into nearly any necessary shape or format to achieve compatibility with virtually any grow system or format.

### B. Hydrogel Substrate Methodology

In one embodiment, to manufacture a hydrogel substrate, primary ingredients (gelling agent(s) and cross linkers) and any secondary ingredients (additives) may be assembled to achieve desired results.

Gelling agent is hydrated in water to create a homogenous, saturated solution, which becomes the base of the substrate mix. This requires specific time to hydrate the material (gelling agent), as well as specific temperature to achieve saturation and homogeneity. Agitation is typically applied to ensure complete saturation and homogeneity. The base solution is brought to a specific temperature for a specific period of time, which are specific to the gelling agent selected.

Once the base is prepared, various additives may be incorporated to achieve various attributes and characteristics, based on the specific desired outcome or use of the hydrogel substrate. A system to thoroughly mix the solution ensures complete homogenization of the material. After homogenization of the material, sparge tubes may be used to introduce or increase concentration of dissolved gases or increase porosity and the volume to mass ratio of the finished solution. Once the material has been thoroughly mixed, it can be deposited into a holding vessel for dispensing. Dispensing of the finished solution may occur through pouring, coating, layering, spraying, or aerosolizing the solution into molds, vessels, sheets, and the like. The gel point, or temperature at which the finished solution turns from a flowing liquid into a semi-solid, of the finished solution is higher than the required operational temperature range for growing plants in the medium.

Due to the unique nature of hydrogel material, in that it can be poured into molds, vessels, sheets, and the like, as well as spay applied or aerosolized onto a suitable surface, it is possible to achieve any variety of formats and/or surface area-to-volume ratios for the substrate. These include traditional formats such as “plugs”, which are commonly used in the agricultural industry, but also includes novel formats such as sheets of material with varying thickness or any other moldable format that a grower or customer may desire to accommodate their specific needs. Other illustrative examples may consider the 3D architecture of final material, including but not limited to: irregular porous plug (a sponge like structure); spheres of uniform or mixed sizes, cubes of uniform or mixed sizes, noodles or fine strings, and irregular polyhedron chunks, and/or mixtures thereof.

In no way limiting, a hydrogel substrate finds use for a variety of applications, such as a substrate for floriculture and horticulture; a substrate or base material for sterile culture and sub-culture (similar to agar culture); substrate for cultivating mushrooms; tissue culturing; cloning from plant cuttings; aquaculture; and the like.

### C. Hydrogel Substrate for Biological Growth

While unique in its material attributes and characteristics, a hydrogel substrate can be used in a manner very similar to other biological growth substrates, such as plant growth substrates. Upon producing or otherwise obtaining a hydrogel substrate as described above, very little, and in fact, in many cases nothing different, is required for growers when it comes to modifying their method of plant propagation or growing operation in order to use an instant hydrogel substrate.

Furthermore, the unique attributes of hydrogel as a substrate allows for significant operational curtailment to reduce pests and pathogens. Growers must typically develop a wide variety of interventions to prevent pests and pathogens that are endemic to traditional substrates. As a totally unique material, pests and pathogens do not have the ability to use a hydrogel substrate as a vector to infect plants. Additionally, hydrogel, as a primarily water-based material, can maintain plant health in the event of operational failures such as water pump failures that result in a lack of available hydration to the plant(s). In this case, the hydrogel is able to supply water directly to the plant via the material in the event that water is not provided by growing operations. Furthermore, many modern agricultural methods, such as hydroponics, aeroponics, and aquaculture, incorporate water recirculation. As a substrate, hydrogel is able to prevent the release of particulate matter into the water system, unlike “traditional” substrates, thus ensuring water recirculation efficiency.

As a completely customizable material, an instant hydrogel substrate can incorporate attributes and characteristics specific to the use of the grower. For seed-based production, growers can utilize a hydrogel substrate in a manner similar or identical to traditional substrates. For example, an instant hydrogel substrate may be “dibbled” (i.e., a small hole put into the top of the material) or not. For plant propagation by cutting (i.e., cloning), the grower need only insert the cut plant into an instant hydrogel substrate material. Uniquely, as a sterile or nearly sterile substrate, an instant hydrogel substrate may not require the grower to apply additional interventions, such as rooting hormone, in order to increase viability from cuttings. In all cases, whether seed-based or cutting-based propagation, plants require less water than otherwise required during germination and propagation. As a water-based material, an instant hydrogel substrate has very high moisture availability that is able to germinate or root a cutting with great success, which is completely unlike traditional substrates that require frequent, if not near continuous, hydration to ensure the substrate material has moisture available to the seed or cutting.

Plants: “Plant” includes any of various photosynthetic, eukaryotic, multicellular organisms of the kingdom Plantae characteristically producing embryos, containing chloroplasts, and having cellulose cell walls. The present application includes both angiosperm (monocots and dicots) and gymnosperm plants, and includes whole plant as well as any part of a plant, such as leaf, root, shoot, stolon, tuber, runner, cane, cutting, seed, flower, etc. In no way limiting, the present methodology and compositions may be used for growing tomato, potato, soybean, maize, turfgrass, rice, oat, wheat, barley, sorghum, orchid, iris, lily, onion, palm, pine, tobacco, Eucalyptus, Populus, Liquidambar, Acacia, teak, mahogany, cotton, tobacco, mustards, orange, apple, pear, cherry, peach, plum, melons, grapes, strawberry, blackberry, raspberry, blueberry, cranberry, loganberry, bananas, citrus, sugar beet, broccoli, cauliflower, celery, cilantro, lettuce, spinach, eggplant, pumpkin, squash, cassava, sweet potato, pepper, poinsettia, geranium, almond, peanut, pistachio, walnut, bean, alfalfa, carrot, strawberry, lettuce, oak, maple, walnut, rose, mint, squash, daisy, geranium, avocado, artichoke, olives, coconut, jojoba, and cactus.

“Fruit” or “fruits” in the botanical sense refers to the seed-bearing structure in flowering plants (also known as angiosperms) formed from the ovary after flowering, including common fruits such as apples, bananas, grapes, oranges, melons, dates, coconuts, and berries, such as strawberries, but also less common fruits such as bean pods, corn kernels, tomatoes, and wheat grains. However, and as used herein, “fruit” includes any plant or part thereof safe for human or animal consumption.

“Small fruit” includes but not limited to strawberry, raspberry (any color), blackberry, blueberry and/or black-raspberry. A small fruit refers to the plant itself as a whole, as well as any part thereof, such as a berry, seedling, stolon, runner, seed, leaf, cane, or root cutting.

“Vegetable” or “vegetables” in the botanical sense means any plant part consumed for food that is not a fruit or seed. However, and as used herein, vegetable refers to any edible stems, stalks, roots, tubers, bulbs, leaves, flowers, some fruits, pulses, fungi, algae, and the like. Exemplary vegetables include but are not limited to lettuces, herbs, Brassicas, cilantro, carrot, potato, pepper, radish, lettuces, cauliflower, tomato, peas, beans, mushroom, truffle, Spirulina, and moringa. Exemplary vegetables include but not limited to Apiaceae (formerly Umbelliferae)—Celery or Carrot Family; Apocynaceae—Periwinkle Family; Asteraceae (formerly Compositae)—Daisy Family; Bignoniaceae—Bignonia Family; Boraginaceae—Forget-me-Not Family; Brassicaceae (formerly Cruciferae)—Cabbage Family; Caesalpiniaceae, Fabaceae, Mimosaceae, Papilionaceae (formerly Leguminosae)—Bean Family; Campanulaceae—Bellflower Family; Caryophyllaceae—Pink Family; Clusiaceae (formerly Guttiferae)—St. John's Wort Family; Convolvulaceae—Bindweed Family; Ericaceae—Heath Family; Geraniaceae—Geranium Family; Gesneriaceae—African Violet Family; Hydrophyllaceae—Waterleaf Family; Iridaceae—Iris Family; Lamiaceae (formerly Labiatae)—Mint or Nettle Family; Liliaceae—Lily Family; Malvaceae—Mallow Family; Musaceae—Banana Family; Oxalidaceae—Wood Sorrel Family; Papaveraceae—Poppy Family; Plumbaginaceae—Leadwort Family; Polemoniaceae—Phlox Family; Primulaceae—Primrose Family; Ranunculaceae—Buttercup Family; Rosaceae—Rose Family; Rubiaceae—Bedstraw Family; Saxifragaceae—Saxifrage Family; Scrophulariaceae—Figwort Family; Solanaceae—Potato Family and Nightshades; and Violaceae—Violet Family.

In some embodiments, plants are selected from adzuki, alfalfa, broccoli, buckwheat, cabbage, cauliflower, chia, chives, clover, dill, fenugreek, flax, garbanzo bean, garlic, kale, kidney bean, lentil bean, mung bean, mustard, navy bean, oats, peas, pinto bean, pumpkin, radish, red clover, soy bean, sunflower, wheat berry, and wheat grass.

In some embodiments, one or more plants are selected from one or more herbs and spices. In some embodiments, the spices are selected from allspice (Pimenta dioica), angelica (Angelica archangelica), anise (Pimpinella anisum), asafoetida (Ferula assa-foetida), bay leaf (Laurus nobilis), basil (Ocimum basilicum), bergamot (Monarda species), black cumin (Nigella sativa), black mustard (Brassica nigra), black pepper (Piper nigrum), borage (Borago officinalis), brown mustard (Brassica juncea), burnet (Sanguisorba minor and S. officinalis), caraway (Carum carvi), cardamom (Elettaria cardamomum), cassia (Cinnamomum cassia), catnip (Nepeta cataria), cayenne pepper (Capsicum annuum), celery seed (Apium graveolens, variety dulce), chervil (Anthriscus cerefolium), chicory (Cichorium intybus), chili pepper (Capsicum species), chives (Allium schoenoprasum), cicely (Myrrhis odorata), cilantro (Coriandrum sativum), cinnamon (Cinnamomum verum), clove (Syzygium aromaticum), coriander (Coriandrum sativum), costmary (Tanacetum balsamita), cumin (Cuminum cyminum), curry, dill (Anethum graveolens), fennel (Foeniculum vulgare), fenugreek (Trigonella foenum-graecum), filé (Sassafras albidum), ginger (Zingiber officinale), grains of paradise (Aframomum melegueta), holy basil (Ocimum tenuiflorum), horehound (Marrubium vulgare), horseradish (Armoracia rusticana), hyssop (Hyssopus officinalis), lavender (Lavandula species), lemon balm (Melissa officinalis), lemon grass (Cymbopogon citratus), lemon verbena (Aloysia citrodora), licorice (Glycyrrhiza glabra), lovage (Levisticum officinale), mace (Myristica fragrans), marjoram (Origanum majorana), nutmeg (Myristica fragrans), oregano (Origanum vulgare), paprika (Capsicum annuum), parsley (Petroselinum crispum), peppermint (Mentha xpiperita), poppy seed (Papaver somniferum), rosemary (Salvia rosmarinus), rue (Ruta graveolens), saffron (Crocus sativus), sage (Salvia officinalis), savory (Satureja hortensis and S. montana), salt, sesame (Sesamum indicum), sorrel (Rumex species), star anise (Illicium verum), spearmint (Mentha spicata), tarragon (Artemisia dracunculus), thyme (Thymus vulgaris), turmeric (Curcuma longa), vanilla (Vanilla planifolia and V. tahitensis), wasabi (Eutrema japonicum), and white mustard (Sinapis alba). In some embodiments, the spices are selected from saffron, garlic, onion, and mustard seed.

### D. Hydrogel Substrate Blend

In other embodiments, as explained below, a biological material, such as a plant or fungus, can grow in or on a hydrogel substrate blend, comprising hydrogel blended with one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material in varying percentages, compositions, states of matter (solid, liquid, aerosol, etc.), particle sizes, and the like, thereby yielding a blended hydrogel substrate.

It is understood that a hydrogel substrate blend may comprise varying mixture composition, percentage composition, particle sizes, and states of matter (solid, liquid, aerosol, etc) of hydrogel with one or more substrate materials including but not limited to soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material. For example, and in no way limiting, a hydrogel substrate blend may comprise 90% coco coir and 10% hydrogel, or 85% coco coir and 15% hydrogel, or 80% coco coir and 20% hydrogel, or 75% coco coir and 25% hydrogel, or 70% coco coir and 30% hydrogel, or 65% coco coir and 35% hydrogel, or 60% coco coir and 40% hydrogel, or 55% coco coir and 45% hydrogel, or 50% coco coir and 50% hydrogel, all based on dry weights.

In other embodiments, a hydrogel substrate blend may comprise a mixture of hydrogel and one or more substrate materials, such as soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material, each with varying percentages. For example, and in no way limiting, a hydrogel substrate blend may comprise 70% coco coir, 20% peat, and 10% hydrogel. In another example, a hydrogel substrate blend may comprise 70% coco coir, 20% tree fiber, and 10% hydrogel.

In other embodiments, a hydrogel substrate blend may comprise varying particle sizes. For example, and in no way limiting, a hydrogel substrate blend may comprise 90% coco coir and 10% hydrogel, wherein the particles have uniform size or varying sizes. For instance, and non-limiting, hydrogel substrate blend may comprise 90% coco coir and 10% hydrogel, wherein the particles have 1 mm size. For example, and in no way limiting, a hydrogel substrate blend comprising 90% coco pith sieved at a fraction size of 1 mm may be combined with a hydrogel dried media sieved at 1 mm to create a homogeneous structure. The coco in this instance would allow for optimized capillary action not present with hydrogel alone for quicker water absorption. Also, the coco will allow for an extended shelf life of the plug itself, allowing longer term crops or biological materials to last in the material.

In other embodiments, a hydrogel substrate blend may comprise a blend of peat and hydrogel; soil and hydrogel; rock wool and hydrogel; wood and hydrogel; wood chips or mulch and hydrogel; wood fiber and hydrogel; processed wood fiber and hydrogel; tree fibers and hydrogel; hemp and hydrogel; bamboo and hydrogel; tree bark and hydrogel; sand and grit, and hydrogel; perlite and hydrogel; pumice and hydrogel; clay and hydrogel; vermiculite and hydrogel; biochar and hydrogel; natural or processed raw material and hydrogel;, and/or synthetic material and hydrogel; each in varying percentages, compositions, states of matter (solid, liquid, aerosol, etc.), particle sizes, and the like.

In other embodiments, a hydrogel substrate blend may comprise varying states of matter. For example, and non-limiting, a hydrogel substrate blend may comprise a mixture of solid particles and wet or liquid hydrogel. For instance, and non-limiting, a hydrogel substrate blend may comprise 90% coco coir and 10% hydrogel, wherein the coco coir is solid particles and the hydrogel is a liquid or wet gel, which after blending the coco coir and hydrogel together to form a homogenous mixture, the present inventors contemplate applying a sprayer to spray a hydrogel substrate blend as a liquid for use as a hydrogel substrate blend.

In some embodiments, a hydrogel substrate blend may comprise an aerosol comprising a mixture of solid particles suspended in a liquid or wet hydrogel, which may be applied in various combinations and rates.

In other embodiments, a hydrogel substrate blend may be dehydrated and then rehydrated for when ready for use. For example, and in no way limiting, a hydrogel substrate blend may be dehydrated for storage, shipping, transportation, and the like, and then rehydrated when ready for use as a biological growth substrate.

### E. Hydrogel Bonded Plug

Bonded plugs provide a uniform and optimal environment for seed germination, fast and efficient rooting, and tissue culture, and may be optimized for a given plant or biological material with different substrate media. Traditionally, bonded plugs comprise a substrate, such as peat, and a binder, such as an adhesive or glue, to hold the plug together.

The present inventors developed a hydrogel bonded plug, wherein said plug comprises one or more substrates bonded with hydrogel, rather than a synthetic glue or adhesive. For example, a hydrogel bonded plug may comprise 90% coir and 10% hydrogel based on dry weights, and such hydrogel bonded plug provides a fully biodegradable material for supporting biological growth. In other embodiments, a hydrogel bonded plug may comprise a blend of peat and hydrogel; coco and hydrogel; soil and hydrogel; rock wool and hydrogel; wood and hydrogel; wood chips or mulch and hydrogel; wood fiber and hydrogel; processed wood fiber and hydrogel; tree fibers and hydrogel; hemp and hydrogel; bamboo and hydrogel; tree bark and hydrogel; sand and grit, and hydrogel; perlite and hydrogel; pumice and hydrogel; clay and hydrogel; vermiculite and hydrogel; biochar and hydrogel; natural or processed raw material and hydrogel;, and/or synthetic material and hydrogel; each in varying percentages, compositions, states of matter (solid, liquid, aerosol, etc.), particle sizes, and the like.

By replacing synthetic adhesive and glues with hydrogel, the present inventors realized that an instant hydrogel imparts physical, chemical, and structural benefits to the growing biological material, whereas synthetic adhesive and glues do not.

Additionally, an instant hydrogel bonded plug allows for a cleaner operation compared to traditional bonded plugs, as a hydrogel bonded plug reduces the amount of media pieces separating and falling apart from a plug, reduces clogging filters with media and adhesives, and thereby creating a cleaner work and growth environment for biological material. This is especially important for sterile work, tissue culture, aquaculture, and the like, where cleanliness can significantly impact the growth of biological material. Synthetic glues have been the bonding agent used to date but they are neither compostable or organic. Hydrogel bonded plug can allow for the same benefits, along with added value like fine product tuning, but can also allow for biodegradation, composability, and organic certification.

The following Examples are illustrative and do not limit the disclosure.

### Example 1: Cylindrical Hydrogel Substrate

As explained above, and in one embodiment, a hydrogel substrate can be manufactured with the primary ingredients (gelling agent(s) and cross linkers) and secondary ingredients (additives) and assembled to achieve desired results. Gelling agent is hydrated in water to create a homogenous, saturated solution, which becomes the base of the substrate mix. This requires specific time to hydrate the material (gelling agent), as well as specific temperature to achieve saturation and homogeneity. Agitation is typically applied to ensure complete saturation and homogeneity. The base solution is brought to a specific temperature for a specific period of time, which are specific to the gelling agent selected. Once the base is prepared, various additives are then incorporated to achieve various attributes and characteristics, based on the specific desired outcome or use of the substrate. A system to thoroughly mix the solution ensures complete homogenization of the material. After homogenization of the material, sparge tubes may be used to introduce or increase concentration of dissolved gases or increase porosity and the volume to mass ratio of the finished solution. Once the material has been thoroughly mixed, it can be deposited into a holding vessel for dispensing. Dispensing of the finished solution may occur through pouring, coating, layering, spraying, or aerosolizing the solution into molds of any suitable shape.

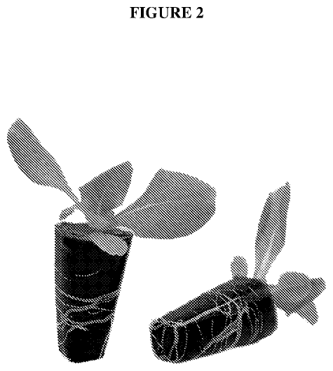

For example, and as shown in FIG. 2, a plant may grow in a cylindrical hydrogel substate, comprising any additive, wherein the plant grows in the hydrogel substrate in the absence of any soil. For instance, and in no way limiting, a cylindrical hydrogel substrate may have an additive for increased water retention, suitable for growing any fruit or vegetable plant, such as a tomato plant.

### Example 2: Hydrogel Substrate Sheet

As explained above, in one example, a hydrogel substrate can be manufactured with the primary ingredients (gelling agent(s) and cross linkers) and secondary ingredients (additives) and assembled to achieve desired results. Gelling agent is hydrated in water to create a homogenous, saturated solution, which becomes the base of the substrate mix. This requires specific time to hydrate the material (gelling agent), as well as specific temperature to achieve saturation and homogeneity. Agitation is typically applied to ensure complete saturation and homogeneity. The base solution is brought to a specific temperature for a specific period of time, which are specific to the gelling agent selected. Once the base is prepared, various additives can be then incorporated to achieve various attributes and characteristics, based on the specific desired outcome or use of the substrate. A system to thoroughly mix the solution ensures complete homogenization of the material. After homogenization of the material, sparge tubes may be used to introduce or increase concentration of dissolved gases or increase porosity and the volume to mass ratio of the finished solution. Once the material has been thoroughly mixed, it can be deposited into a holding vessel for dispensing. Dispensing of the finished solution may occur through pouring, coating, layering, spraying, or aerosolizing the solution into molds of any suitable shape.

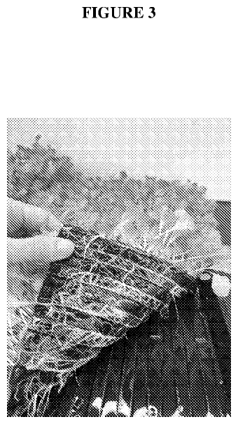

For example, as shown in FIG. 3, a plant may grow in a hydrogel substate sheet, comprising any additive, wherein the plant grows in the hydrogel substrate in the absence of any soil. For instance, and in no way limiting, a hydrogel substrate sheet may have a humectant additive for increased water retention, suitable for growing any fruit or vegetable plant, such as small fruits or lettuces.

### Example 3: Hydrogel Blends

A biological material, such as a plant or fungus, can grow in or on a hydrogel substrate blend, comprising hydrogel blended with one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material in varying percentages, compositions, states of matter (solid, liquid, aerosol, etc.), particle sizes, and the like, thereby yielding a blended hydrogel substrate.

It is understood that a hydrogel substrate blend may comprise varying mixture composition, percentage composition, particle sizes, and states of matter (solid, liquid, aerosol, etc) of hydrogel with one or more substrate materials including but not limited to soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material. For example, and in no way limiting, a hydrogel substrate blend may comprise 90% coco coir and 10% hydrogel, or 85% coco coir and 15% hydrogel, or 80% coco coir and 20% hydrogel, or 75% coco coir and 25% hydrogel, or 70% coco coir and 30% hydrogel, or 65% coco coir and 35% hydrogel, or 60% coco coir and 40% hydrogel, or 55% coco coir and 45% hydrogel, or 50% coco coir and 50% hydrogel.

In other embodiments, a hydrogel substrate blend may comprise varying particle sizes. For example, and in no way limiting, a hydrogel substrate blend may comprise 90% peat and 10% hydrogel, wherein the particles have uniform size or varying sizes. For instance, and non-limiting, hydrogel substrate blend may comprise 90% peat and 10% hydrogel, wherein the particles have 1 mm size. For example, and in no way limiting, a hydrogel substrate blend comprising 90% peat sieved at a fraction size of 1 mm may be combined with a hydrogel dried media sieved at 1 mm to create a homogeneous structure.

For example, and using the present methodology and composition, a plant such as lettuce, herbs, Brassica, cilantro, or any other fruit or vegetable plant may be grown in or on a hydrogel substrate blend comprising coco and hydrogel. For instance, lettuce seeds may be germinated in in or on a hydrogel substrate blend comprising 90% coco and 10% hydrogel, based on dry weights.

### Example 4: Hydrogel Bonded Plug

As explained above, and using the instant methodology and compositions, a biological material, such as a plant or fungus, can grow in or on a hydrogel bonded plug, comprising hydrogel bonded with one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material in varying percentages, compositions, states of matter (solid, liquid, aerosol, etc.), particle sizes, and the like, thereby yielding a blended hydrogel substrate.

Unlike traditional bonded plugs comprising a substrate, such as peat, and a binder, such as an adhesive or glue, to hold the plug together, the present inventors developed a hydrogel bonded plug, wherein said plug comprises one or more substrates bonded with hydrogel, rather than a synthetic glue or adhesive.

For example, a hydrogel bonded plug may comprise 90% coir and 10% hydrogel based on dry weights, and such hydrogel bonded plug provides a fully biodegradable material for supporting biological growth.

In other embodiments, a hydrogel bonded plug may comprise a blend of peat and hydrogel; coco and hydrogel; soil and hydrogel; rock wool and hydrogel; wood and hydrogel; wood chips or mulch and hydrogel; wood fiber and hydrogel; processed wood fiber and hydrogel; tree fibers and hydrogel; hemp and hydrogel; bamboo and hydrogel; tree bark and hydrogel; sand and grit, and hydrogel; perlite and hydrogel; pumice and hydrogel; clay and hydrogel; vermiculite and hydrogel; biochar and hydrogel; natural or processed raw material and hydrogel;, and/or synthetic material and hydrogel; each in varying percentages, compositions, states of matter (solid, liquid, aerosol, etc.), particle sizes, and the like.

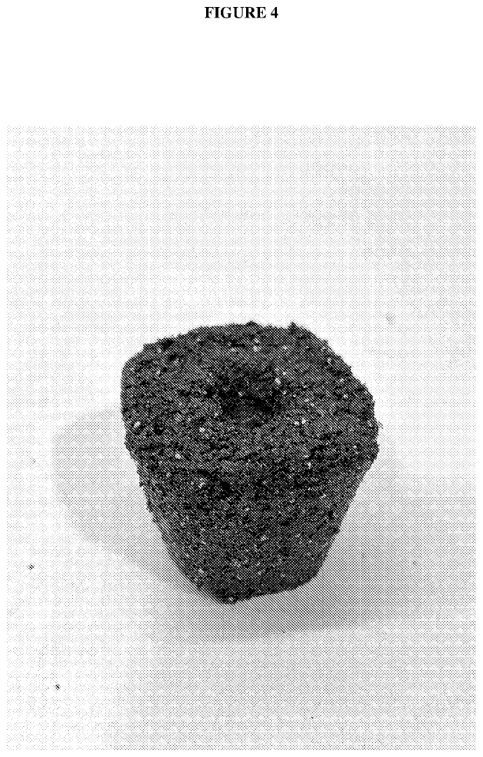

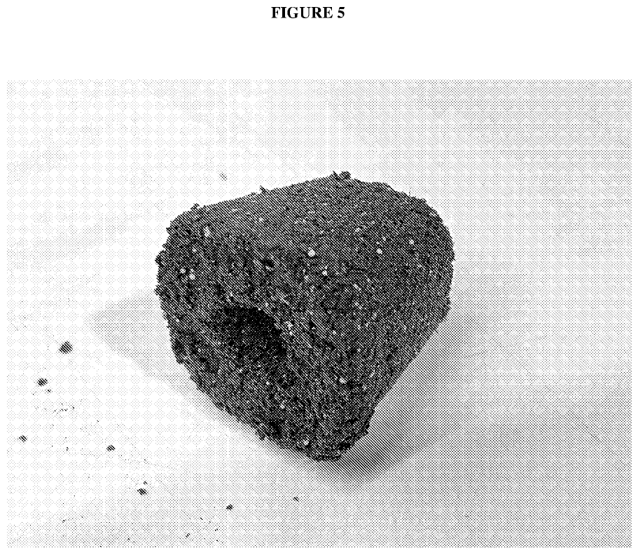

For instance, and using the present methodology and composition, a plant such as lettuce, herbs, Brassica, cilantro, or any other fruit or vegetable plant may be grown in or on a hydrogel bonded plug comprising coco and hydrogel. For instance, lettuce seeds may be germinated in in or on a hydrogel bonded plug comprising 90% coco and 10% hydrogel, based on dry weights. FIGS. 4 and 5 show illustrative hydrogel bonded plugs comprising hydrogel and coco coir.

What is claimed is:

1. A method for growing a plant, comprising
(a) constructing a hydrogel substrate comprising one or more additive ingredients, wherein said hydrogel substrate confers one or more characteristics for supporting plant growth; and
(b) growing a plant in said hydrogel substrate in the absence of soil.

2. The method of claim 1, wherein the one or more additive ingredients is selected from an opacifier additive, a texture additive, a cationic capacity additive, an anti-fouling additive, a humectant additive, and a colorant additive.

3. The method of claim 1, wherein the one or more additive ingredients supports plant growth by conferring one or more characteristics selected from improved nutrient composition, color, light absorption, opacity, elasticity, brittleness, texture heterogeneity, porosity, sterility, antibacterial properties, pH, electrical conductivity (EC), dissolved oxygen, water retention, water capacity, water recirculation, cohesive strength, adhesive strength to non-hydrogel surfaces, freeze-thaw hysteresis, temperature-, light- or pH-based stimuli, gas permeability, shape memory/hysteresis, solvent exchange behavior, thermal conductivity, anti-fouling properties, surface roughness, suspension of solids, compostability, biodegradability, oxidation-reduction potential, cationic exchange capacity, and time dependent release of nutrients.

4. The method of claim 1, wherein said plant is selected from tomato, potato, carrot, garlic, soybean, maize, turfgrass, cilantro, rice, oat, wheat, barley, sorghum, orchid, iris, lily, onion, palm, pine, tobacco, Eucalyptus, Populus, Liquidambar, Acacia, teak, mahogany, cotton, tobacco, mustards, orange, apple, pear, cherry, peach, plum, melons, grapes, strawberry, blackberry, raspberry, blueberry, cranberry, loganberry, bananas, citrus, sugar beet, broccoli, cauliflower, celery, lettuce, spinach, eggplant, pumpkin, squash, cassava, sweet potato, pepper, poinsettia, geranium, almond, peanut, pistachio, hazelnut, walnut, bean, alfalfa, carrot, strawberry, lettuce, oak, maple, walnut, rose, mint, squash, daisy, geranium, avocado, artichoke, olives, coconut, jojoba, Brassica, and cactus.

5. The method of claim 1, wherein the hydrogel substrate comprises a humectant additive, wherein said hydrogel substrate confers increased moisture retention.

6. The method of claim 1, wherein said hydrogel substrate is constructed into a cylindrical hydrogel substrate.

7. The method of claim 1, wherein said hydrogel substrate is constructed into a hydrogel substrate sheet.

8. The method of claim 1, wherein said hydrogel substrate is constructed into irregular porous plug, spheres of uniform or mixed sizes, cubes of uniform or mixed sizes, noodles or fine strings, and irregular polyhedron chunks, and/or mixtures thereof.

9. A method for growing a plant, comprising
(a) obtaining a hydrogel substrate comprising one or more additive ingredients, wherein said hydrogel substrate confers one or more characteristics for supporting plant growth; and
(b) planting a plant seed or vegetatively propagating a plant, or part thereof, in said hydrogel substrate in the absence of soil.

10. The method of claim 9, wherein said hydrogel substrate is constructed into a cylindrical hydrogel substrate.

11. The method of claim 8, wherein said hydrogel substrate is constructed into a hydrogel substrate sheet.

12. The method of claim 9, wherein said hydrogel substrate is constructed into irregular porous plugs; sphere of uniform or mixed sizes, cubes of uniform or mixed sizes, noodles or fine strings, and irregular polyhedron chunks, and/or mixtures thereof.

13. The method of claim 9, wherein the one or more additive ingredients is selected from an opacifier additive, a texture additive, a cationic capacity additive, an anti-fouling additive, a humectant additive, and a colorant additive.

14. A method for growing a plant, comprising
(a) constructing a hydrogel substrate comprising one or more additive ingredients, wherein said hydrogel substrate confers one or more characteristics for supporting plant growth;
(b) forming said hydrogel substrate into a cylindrical shape to yield a hydrogel substrate cylinder; and
(c) growing a plant in said hydrogel substrate cylinder.

15. A method for growing a plant, comprising
(a) constructing a hydrogel substrate comprising one or more additive ingredients, wherein said hydrogel substrate confers one or more characteristics for supporting plant growth;
(b) forming said hydrogel substrate into a sheet to yield a hydrogel substrate sheet; and
(c) growing a plant in said hydrogel substrate sheet.

16. A composition comprising a hydrogel substrate cylinder, wherein the composition does not contain soil.

17. The composition of claim 16, further comprising a plant.

18. A composition comprising a hydrogel substrate sheet, wherein the composition does not contain soil.

19. The composition of claim 18, further comprising one or more plants.

20. A method for growing a plant, comprising
(a) obtaining a hydrogel substrate cylinder, wherein said hydrogel substrate cylinder confers one or more characteristics for supporting plant growth; and
(b) growing a plant in said hydrogel substrate sheet.

21. A method for growing a plant, comprising
(a) obtaining a hydrogel substrate sheet, wherein said hydrogel substrate sheet confers one or more characteristics for supporting plant growth; and
(b) growing one or more plants in said hydrogel substrate sheet.

22. A method for growing a biological material, comprising
(a) obtaining a hydrogel substrate, wherein said hydrogel substrate sheet is shaped, molded, and formed into irregular porous plugs, spheres of uniform or mixed sizes, cubes of uniform or mixed sizes, noodles or fine strings, irregular polyhedron chunks, and/or mixtures thereof; and
(b) growing a biological material on said hydrogel substrate.

23. The method of claim 22, wherein said biological material is a plant, an ornamental flower, fruit, a vegetable, fungus, mushroom, bacterium, or bacterial culture.

24. A method of any of the preceding claims, wherein said hydrogel substrate does not comprise methyl cellulose.

25. A composition of any of the preceding claims, wherein said hydrogel substrate does not comprise methyl cellulose.

26. A hydrogel substrate blend, comprising a hydrogel blended with one or more materials suitable for plant growth.

27. The hydrogel substrate blend of claim 26, wherein said raw material is selected from one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

28. The hydrogel substrate blend of claim 26 or claim 27, wherein said blend comprises about 90% coco coir and about 10% hydrogel, based on dry weights.

29. A hydrogel substrate blend of any preceding claim, wherein said blend comprises about 90% peat and about 10% hydrogel, based on dry weights.

30. A hydrogel substrate blend of any of the preceding claims, wherein said blend is an aerosolized product.

31. A hydrogel substrate blend of any of the preceding claims, wherein said blend is an aerosolized product comprising blended coco coir and wet hydrogel.

32. A hydrogel substrate blend of any of the preceding claims, wherein said hydrogel substrate does not comprise methyl cellulose.

33. A method for growing a biological material, comprising
(a) obtaining a hydrogel substrate blend, wherein said hydrogel substrate blend comprises hydrogel and one or more materials suitable for biological growth; and
(b) growing a biological material in said hydrogel substrate blend under conditions suitable for growth of said biological material.

34. The method of claim 33, wherein said one or more materials is selected from soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

35. The method of claims 33 or 34, wherein said hydrogel substrate blend comprises hydrogel substrate and coco coir.

36. The method of any of the preceding claims, wherein said hydrogel substrate blend comprises about 90% coco coir and about 10% hydrogel, based on dry weights.

37. The method of claims 33 or 34, wherein said hydrogel substrate blend comprises hydrogel substrate and peat moss.

38. A hydrogel bonded plug, wherein said plug does not comprise any synthetic glue or adhesive.

39. The hydrogel bonded plug of claim 38, wherein said plug comprises hydrogel substrate and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material.

40. The hydrogel bonded plug of any of the preceding claims, wherein said hydrogel substrate does not comprise methyl cellulose.

41. The hydrogel bonded plug of any of the preceding claims, further comprising a biological material.

42. The hydrogel bonded plug of any of the preceding claims, further comprising a biological material selected from a plant, an ornamental flower, fruit, a vegetable, fungus, mushroom, bacterium, and bacterial culture.

43. A compostable hydrogel bonded plug, wherein said hydrogel bonded plug does not comprise any synthetic glue or adhesive.

44. A method for growing a biological material, comprising
(a) obtaining a hydrogel bonded plug, wherein said hydrogel bonded plug does not comprise any synthetic glue or adhesive; and
(b) growing a biological material in said hydrogel bonded plug under conditions suitable for growth of said biological material.

45. The method of claim 44, wherein said hydrogel bonded plug comprises hydrogel substrate and one or more of soil, coco coir, peat moss, rock wool, wood, wood chips or mulch, wood fiber, processed wood fiber, tree fibers, hemp, bamboo, tree bark, sand and grit, perlite, pumice, clay, vermiculite, biochar, natural or processed raw material, and/or synthetic material

46. The method of claim 44 or claim 45, wherein said hydrogel bonded plug comprises about 90% coco coir and about 10% hydrogel, based on dry weights.

47. The method of any of the preceding claims, wherein said biological material is selected from a plant, an ornamental flower, fruit, a vegetable, fungus, mushroom, bacterium, and bacterial culture.

48. The method of any of the preceding claims, wherein said biological material is a plant.

49. The method of any of the preceding claims, wherein said plant is selected from lettuce, cilantro, Brassica, herbs, and vegetables

50. The hydrogel substrate of any of the preceding claims, wherein said hydrogel substrate is dehydrated.

51. The hydrogel substrate blend of any of the preceding claims, wherein said hydrogel substrate blend is dehydrated.

52. The hydrogel bonded plug of any of the preceding claims, wherein said hydrogel bond plug is dehydrated.

53. A method for growing a biological material, comprising
(a) obtaining a hydrogel substrate, wherein said hydrogel substrate is dehydrated;
(b) rehydrating said hydrogel substrate; and
(c) growing a biological material in or on said hydrogel substrate.

54. A method for growing a biological material, comprising
(a) obtaining a hydrogel substrate blend, wherein said hydrogel substrate blend is dehydrated;
(b) rehydrating said hydrogel substrate blend; and
(c) growing a biological material in or on said hydrogel substrate blend.

55. A method for growing a biological material, comprising
(a) obtaining a hydrogel bonded plug, wherein said hydrogel bonded plug is dehydrated;
(b) rehydrating said hydrogel bonded plug; and
(c) growing a biological material in or on said hydrogel bonded plug.
